(19) United States
(12) Patent Application Publication
(10) Pub. No.: US 2014/0185630 A1
(43) Pub. Date: Jul. 3, 2014

(54) Systems And Methods For Performing Fiber Node Splits Using Remote QAM Modulation And Demodulation

(71) Applicant: CASA SYSTEMS, INC., Andover, MA (US)

(72) Inventors: David Fox, Bolton, MA (US); Weidong Chen, Boxborough, MA (US); Jerry Guo, Windham, NH (US); Douglas Rosich, North Reading, MA (US)

(73) Assignee: CASA SYSTEMS, INC., Andover, MA (US)

(21) Appl. No.: 13/733,486

(22) Filed: Jan. 3, 2013

(51) Int. Cl. H04L 29/08

(52) U.S. Cl. CPC H04L 67/325
USPC 370/458

(57) ABSTRACT

Systems and methods are provided for performing fiber node splits in DOCSIS cable systems by performing remote modulation and/or demodulation in the fiber node. In the downstream direction, a high-speed digital fiber optic interface can be used to send data from the CMTS to the fiber node, which then modulates the data onto separate downstream interfaces for subsequent distribution of the downstream data to CMs and/or STBs. In the upstream direction, different upstream interfaces from the CMs and/or STBs may be demodulated into digital streams which can then be combined into a single, time division multiplexed digital stream that is transmitted to the CMTS. As such, the modulation and demodulation functions are performed remotely in the fiber node instead of at the CMTS. This allows the fiber portion of the network to use less-expensive, off-the-shelf networking technologies such as Ethernet, and allows for more data to be sent over the fiber network such that additional fibers and/or wavelengths are not required when performing a node split.

### BACKGROUND OF THE INVENTION

1. Field of the Invention

The present invention relates to systems and methods for performing fiber node splits using remote QAM modulation and demodulation.

2. Related Art

Cable Modems (CMs), which can be found in both homes and businesses, communicate to a device which is known as a Cable Modem Termination System (CMTS). The signals sent between these devices traverse a network generally composed of both coaxial cable and fiber optic cable, known as a Hybrid Fiber-Coax (HFC) cable plant. The protocol used to communicate between the CMTS and CMs has been standardized by the CableLabs organization, and is collectively known as DOCSIS (Data Over Cable Service Interface Specifications). The set of DOCSIS specifications defines the physical layer, media access control layer, and application interface layer.

FIG. 1 shows a typical HFC plant which includes: a CMTS 100; fiber cable 102; coaxial cable 104, fiber node 106, RF line amplifiers 108, and CMs and/or set-top boxes (STBs) 110. The CMTS 100 sends data traffic and control traffic over the HFC network to the CMs and/or STBs 110. The HFC network allows for bi-directional communication between the CMTS and the CMs. The CMTS attaches to the HFC network via coaxial cable. The signals being sent over the coaxial cables are then translated to fiber optic signals and then back to coaxial cable via the fiber node 106. The translation to fiber optic signals is performed in order to allow for greater distances between the CMTS and the CMs.

The HFC network can support a range of frequencies up to about 1 GHz. The 1 GHz range is broken up into a lower spectrum, typically from 5 to 65 MHz, which is used for transmission in the upstream direction, from the CMSs to the CMTS, and a higher spectrum, which can reach up to 1 GHz, which is used in the downstream direction. In the upstream direction, the spectrum is further divided up into channels which are typically 3.2 or 6.4 MHz wide. These channels are shared in a time division multiplexed fashion by all of the CMs on the node. Typically there can be anywhere from 100 to 500 CMs on a single node.

Within each channel, Quadrature Amplitude Modulation (QAM) is used to represent digital values by varying both the phase and amplitude of the signal. When the QAM modulated signal needs to be sent across a fiber optic connection, fiber nodes 106 are used to translate the signal. The fiber node uses a special amplitude modulated laser such that the amplitude modulated signal may be reproduced across the fiber connection. In the current art, the entire downstream spectrum may be sent across one fiber, and the entire upstream spectrum may be sent across a separate fiber.

“Splitting” the fiber node is a technique currently used to provide more bandwidth to the devices which share the node. When the fiber node is split, the group of CM or STB devices, which previously all shared the same common downstream and upstream interface and spectrum, is split up into two or more groups or sub-nodes. For example, if a node which had 200 CMs sharing the same upstream bandwidth is split in half, then 2 sub-nodes of 100 CMs could be created such that only 100 CMs share the same upstream bandwidth in a sub-node, thereby doubling the amount of available bandwidth.

When a fiber node is split, either separate fiber wavelengths or separate fiber optic cables are needed to send the separate sets of spectrum in the downstream and upstream. If separate wavelengths are used, then more expensive Dense Wavelength Division Multiplexing (DWDM) techniques are required. If separate fiber optic cables are used, then the cables need to be available, and separate lasers are needed to send over those cables. Either way, a fiber node split can be expensive.

### SUMMARY OF THE INVENTION

Systems and methods are disclosed for performing fiber node splits in DOCSIS cable systems by performing remote modulation and/or demodulation in the fiber node. In the downstream direction, a high-speed digital fiber optic interface can be used to send data from the CMTS to the fiber node, which then modulates the data onto separate downstream interfaces for subsequent distribution of the downstream data to CMs and/or STBs. In the upstream direction, different upstream interfaces from the CMs and/or STBs may be demodulated into digital streams which can then be combined into a single, time division multiplexed digital stream that is transmitted to the CMTS. As such, the modulation and demodulation functions are performed remotely in the fiber node instead of at the CMTS. This allows the fiber portion of the network to use less-expensive, off-the-shelf networking technologies such as Ethernet, and allows for more data to be sent over the fiber network such that additional fibers and/or wavelengths are not required when performing a node split.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating a prior art HFC plant;

FIG. 2 is a diagram showing a fiber node, such as the one shown in FIG. 1, split in accordance with the prior art;

FIG. 3 is a diagram showing a fiber node split according to the disclosure herein;

FIG. 4 is a flow diagram showing steps performed in the fiber node in accordance with the present disclosure for sending information upstream;

FIG. 5 is a diagram showing a fiber node split according to the present disclosure; and

FIG. 6 is a flow diagram showing steps performed in the fiber node in accordance with the present disclosure for sending information downstream.

### DETAILED DESCRIPTION OF THE INVENTION

This disclosure relates generally to systems and methods for performing fiber node splits in DOCSIS cable systems by performing remote modulation and/or demodulation in the fiber node. In the downstream direction, a high-speed digital fiber optic interface can be used to send data from the CMTS to the fiber node, which then modulates the data onto separate downstream interfaces for subsequent distribution of the downstream data to CMs and/or STBs. In the upstream direction, different upstream interfaces from the CMs and/or STBs may be demodulated into digital streams which can then be combined into a single, time division multiplexed digital stream that is transmitted to the CMTS. As such, the modulation and demodulation functions are performed remotely in the fiber node instead of at the CMTS. This allows the fiber portion of the network to use less-expensive, off-the-shelf networking technologies such as Ethernet, and allows for more data to be sent over the fiber network such that additional fibers and/or wavelengths are not required when performing a node split. This technology is distinctly different than “CMTS on a pole” technology, where a complete CMTS might be mounted in place of a fiber node. Unlike CMTS on a pole, this technology only “remotes” a portion of the media access control (MAC) and the physical layer (“PHY”), leaving other DOCSIS processing, such as bonding, scheduling, and encryption/decryption, in the CMTS. This allows only the upstream or only the downstream data transmission to be implemented in the fiber node, and makes the fiber node simpler and more reliable than CMTS on a pole.

Since the fiber node typically has several separate physical connections splitting off to different locations, each of these physical connections, referred to herein as sub-nodes, may be independently modulated (in the downstream), or demodulated (in the upstream), and then multiplexed together onto a common, full-duplex fiber connection. The systems and methods disclosed herein can also provide for performing an upstream only or downstream only node split.

In the current art, the upstream and downstream ports of the CMTS are coaxial connections, and the CMTS receives and demodulates QAM modulated signals sent from the CMs and/or STBs, and sends QAM modulated signals to the CMs and/or STBs. One exception to this is “modular” CMTS where the downstream QAM modulation resides in separate edge QAM devices which are connected to the CMTS via fiber and co-located with the CMTS at the head-end. The reason for the coaxial connection to the CMTS is partly historical as fiber optics were never originally part of a cable operator's network. At some point, fiber was introduced into the network in order to allow for greater distances with less distortion and attenuation. In order to avoid impacting the CMTS, special amplitude modulated lasers were added to the network which could reproduce the QAM modulated signal from the coaxial cable, send it over the fiber network, and then translate it back to a coaxial cable.

In the upstream direction, from the CMs and/or STBs to the CMTS, the demodulation function has in the past been performed in the CMTS. This is partly due to the tight synchronization requirements on the upstream interface. Since many CMs share the same coaxial connection, the upstream bandwidth is allocated by the CMTS in a time division multiplexed (TDM) fashion. As such, the burst receivers in the CMTS must be synchronized to the CMs and/or STBs such that the burst receiver knows when a particular CM or STB has started to send data. The CM or STB sends data in “bursts,” where the burst starts with a preamble that allows the burst receiver in the CMTS to lock onto the carrier frequency and the symbol clock of the CM or STB. Periodic messages, known as ranging messages, are sent between the CMs and/or STBs and the CMTS such that the CM or STB can check the DOCSIS timestamp clock of the CM or STB, the power of the CM or STB, and the carrier frequency of the CM or STB, and then tell the CM or STB to make adjustments as required.

In the downstream direction, from the CMTS to the CMs and/or STBs, the QAM modulation has traditionally been performed in the CMTS. Modular CMTS, discussed above, has allowed the QAM modulation to be placed in a separate edge QAM device which is attached to the CMTS via fiber. In order to keep the timing signals from the edge QAM synchronized with the DOCSIS timestamp, the DOCSIS edge QAMs require a separate timing interface signal known as the DOCSIS Timing Interface (DTI). The DTI interface along with the edge QAMs are only designed to work a short distance from the CMTS. Unlike modular CMTS, systems and methods disclosed herein extend the fiber connection out to the remote fiber node and do not require the DTI interface. As such, the single fiber connection may be extended all of the way out to the fiber node and still support separate downstream interfaces when performing a fiber node split.

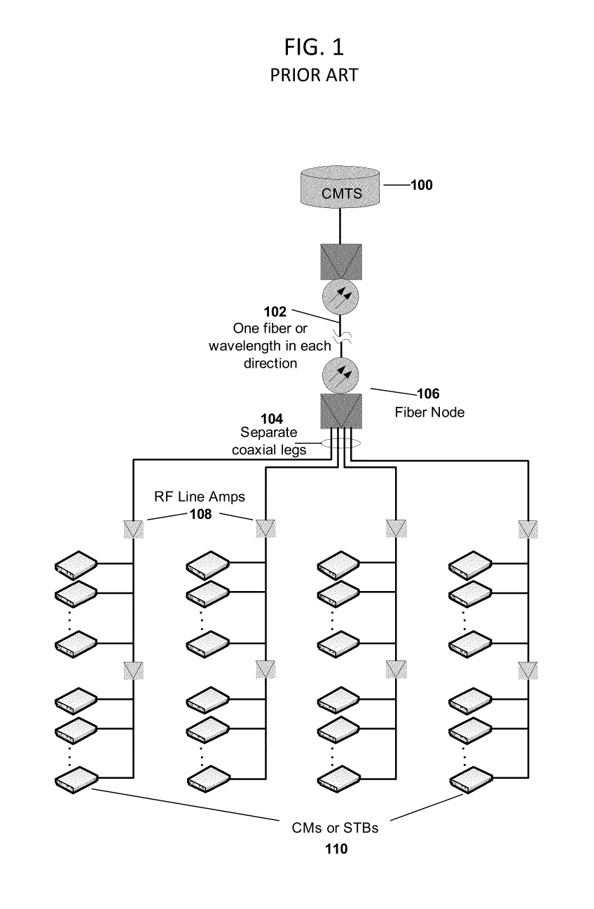

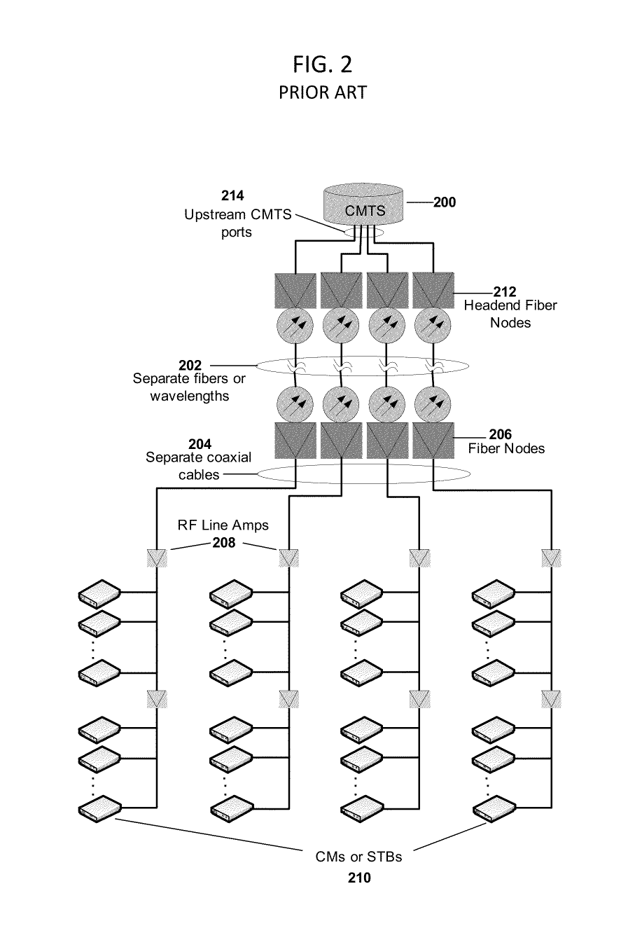

FIG. 2 shows a diagram how a fiber node, such as the one shown in FIG. 1, is split according to the prior art. Typically, a fiber node would have four (4) different coaxial connections or “legs” 204 feeding four (4) different locations as shown in, FIG. 2 for receiving information from CMs or STBs 210 through RF line amps 208. When the node is split, the four different coaxial legs 204, are split out from four different fiber nodes 206. Therefore, in the upstream and downstream directions, three additional lasers are required in order to transmit each of the new nodes on separate fibers or wavelengths. At the head-end, additional fiber receivers 212, and additional CMTS upstream and downstream ports 214, are also required. This all adds considerable expense when splitting the fiber node.

The systems and methods disclosed herein provide a more cost-effective way to split the fiber nodes. While QAM modulation is a good technique for sending data over coaxial cable, and is required in order to maintain compatibility with existing CM devices, QAM modulation may not be the best choice for sending data over a fiber cable. Moving the QAM modulation and demodulation function, traditionally performed in the CMTS, to the fiber node, and changing the interface between the fiber node and the CMTS to a lower-cost and higher-throughput standard which runs over fiber optic interfaces such as Ethernet (including, but not limited to, an Ethernet Passive Optical Network (PON)), provides a cost effective way to split fiber nodes. Methods are presented herein for splitting the fiber node in the upstream direction only, the downstream direction only, or both.

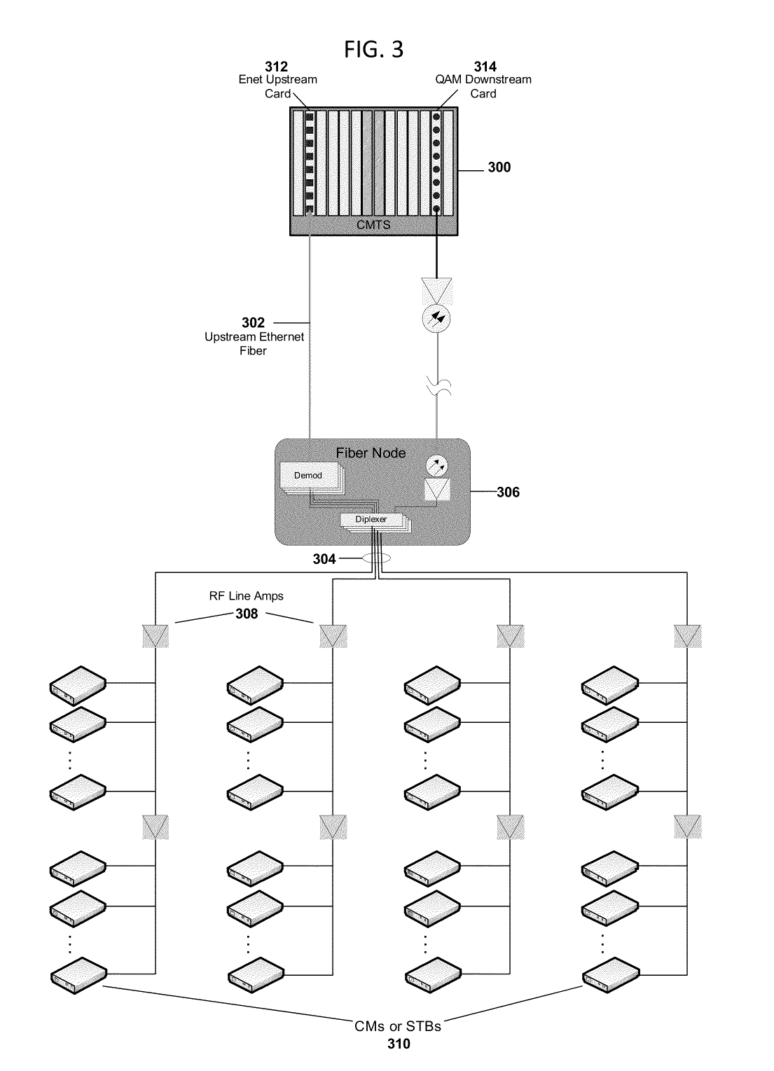

FIG. 3 shows a fiber node, such as the one shown in FIG. 1, split in the upstream direction in accordance with the disclosure herein. As with the fiber node split shown in FIG. 2, four (4) different coaxial legs 304 of the fiber node 306 are split into different sub-nodes. Each sub-node is separately demodulated in the fiber node 306 (e.g., using a demodulation and an associated diplexer, as shown), and the resultant digital data is multiplexed together as Ethernet packets onto a single Ethernet fiber link 302. It is noted that the fiber link 302 could include an Ethernet Passive Optical Network (PON). The upstream Ethernet connection may then be received by a single port of the upstream Ethernet card 312 in the CMTS 300. Current systems have a maximum upstream bandwidth of about 270 Mb/s per node, and future systems are unlikely to extend much beyond 1 Gb/s per node. Therefore, 4 nodes of bandwidth, or 4 Gb/s, may be sent over a single fiber/wavelength. The upstream node split has therefore been accomplished without requiring additional fibers or wavelengths, and expensive amplitude modulated lasers have been replaced by much less expensive single-mode lasers. The need for a head end fiber node to convert from fiber to coaxial cable has also been eliminated.

In order to act as an upstream DOCSIS burst receiver, the fiber node needs certain types of information. This information includes: a copy of the DOCSIS timestamp which is clocked synchronously with the downstream timestamp; information about the configurations in use for the different upstream channels; and information about when each CM device is sending its data. This information is currently available in the defined DOCSIS structures which are sent in the downstream direction. DOCSIS “SYNC” messages carry the current value of the DOCSIS timestamp. These SYNC messages are sent at a regular period in the downstream direction, thereby allowing the fiber node to lock onto the DOCSIS timestamp. A precise DOCSIS clock is used by the upstream burst receiver. This clocking information can be transferred over the fiber connection using known network synchronization standards such as Synchronous Ethernet.

Multiple upstream channels may be defined in the CMTS, and different channel characteristics, such as modulation order and symbol rate, may be defined for each channel. Therefore, in order to demodulate the upstream channel, the fiber node needs to know the characteristics of the upstream channels. These characteristics are currently sent in the DOCSIS Upstream Channel Descriptor (UCD) structures on the downstream channel, and are therefore visible to the fiber node.

The last piece of information needed relates to when bursts of data start and stop from different CMs or STBs. This scheduling information is currently sent in the downstream direction in a structure known as a DOCSIS MAP. The DOCSIS MAP completely defines the usage of all time slots in the upstream direction.

With access to the DOCSIS timing information, UCDs, and MAPs, the fiber node has all of the information it needs to demodulate the bursts of data on the upstream. Once the signal is demodulated, the data may be combined with data from other sub-nodes, and transmitted on a common fiber using a standard such as Ethernet. In addition to forwarding data, the fiber node must also forward status information related to the demodulation function. The protocol used to forward this information can either be proprietary, or the fiber node may take advantage of standards being developed for modular CMTS such as the Upstream External PHY Interface (UEPI).

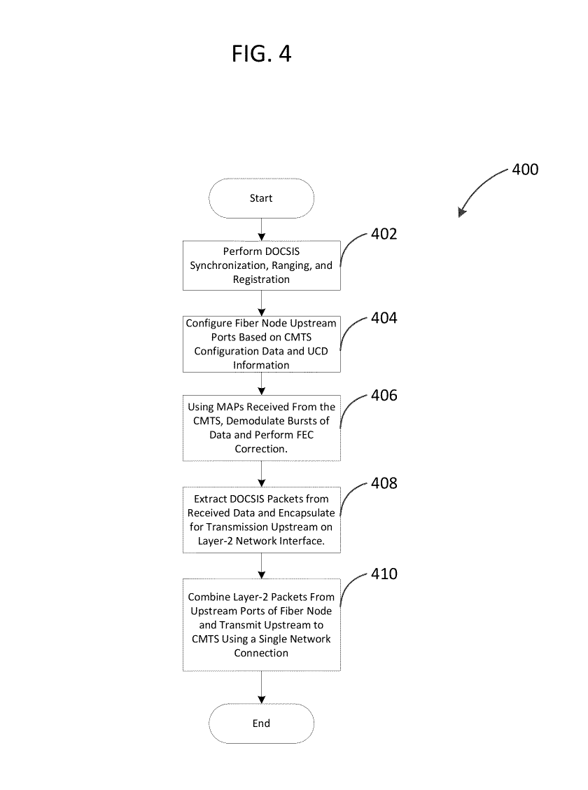

As shown in FIG. 4, the steps performed in the fiber node in an upstream fiber portion of DOCSIS system include performing DOCSIS synchronization, ranging and registration as shown in step 402. Next, as shown in step 404, fiber node upstream ports are configured based on configuration data and UCD information. Then, as shown in step 406, using MAPS received from the CMTS, the fiber node demodulates bursts of data and performs forward error correction (FEC) on the data. Next, as shown in step 408, DOCSIS packets are extracted from the received data and are encapsulated for transmission upstream to the CMTs using a Layer-2 network interface. As shown in step 410, Layer-2 packets from upstream ports of the fiber node are combined and transmitted upstream to the CMTS using a simple network connection (e.g., using the upstream Ethernet fiber 302 of FIG. 3).

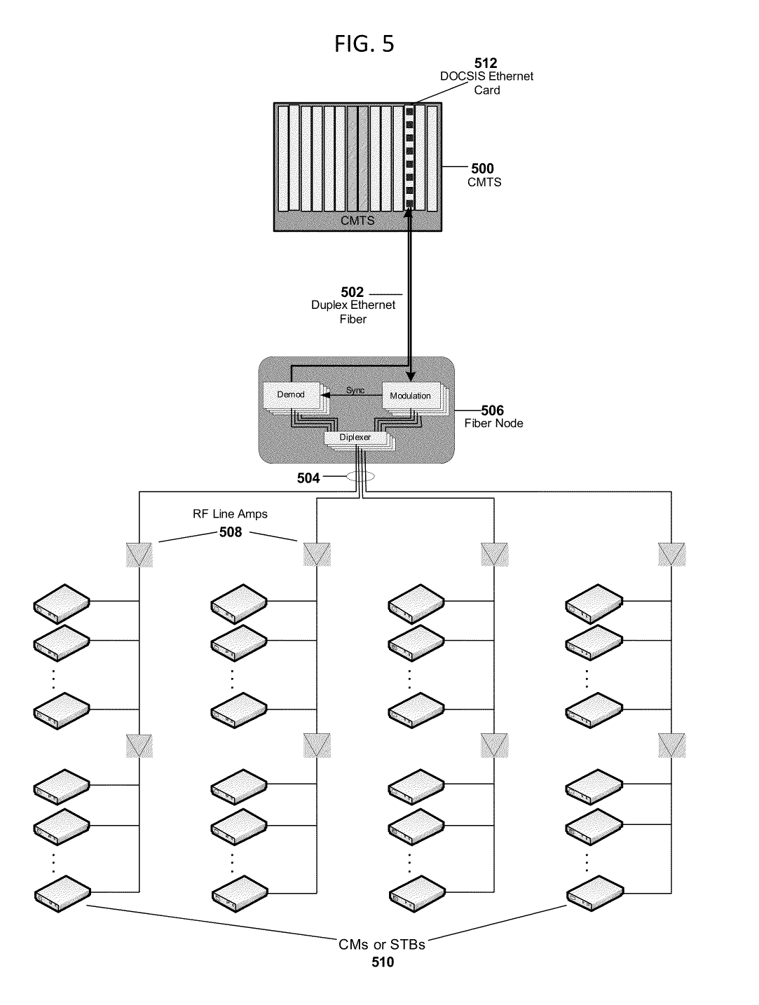

FIG. 5 shows how a fiber node, such as the one shown in FIG. 1, can be split in the downstream direction according to the present disclosure. While a traditional fiber node receives modulated analog data over a fiber network which deploys amplitude modulated lasers, the fiber node described herein receives non-modulated data as packets over a network interface such as Ethernet using a standard network laser. CMTS 500 sends data through DOCSIS Ethernet card 512 over duplex Ethernet fiber 502, to fiber node 506. The fiber node 506 receives and modulates the data, using QAM and an associate diplexer, onto separate downstream interfaces onto coaxial legs 504, through RF line amps 508 to CMs and/or STBs 510. It is noted that the Ethernet fiber 502 could include an Ethernet Passive Optical Network (PON).

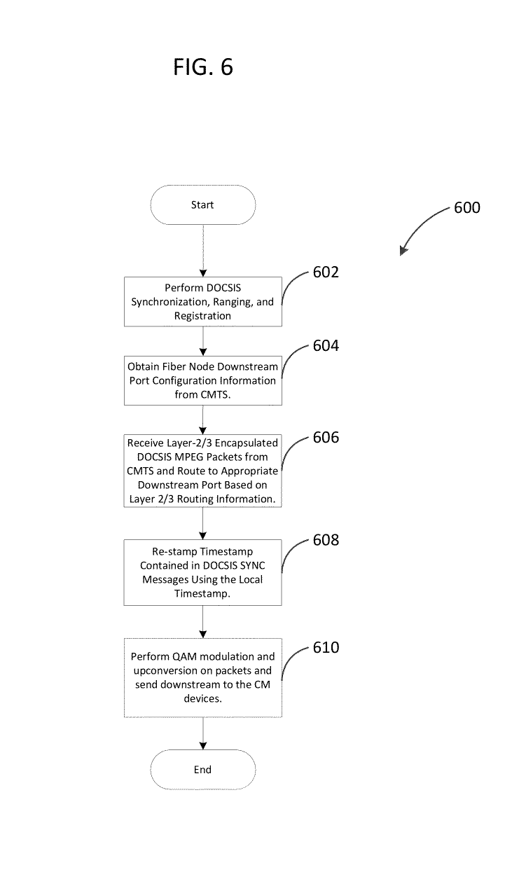

As shown in FIG. 6, the steps performed by the fiber node in the downstream direction include performing DOCSIS synchronization, ranging and registration in step 602. Continuing, in step 604, the fiber node obtains downstream port configuration information from the CMTS. In step 606, the fiber node receives layer 2/3 encapsulated DOCSIS MPEG packets from the CMTS and routes same to the appropriate downstream port based on the layer 213 routing information. As shown in step 608, the fiber node then re-stamps the timestamp contained in the DOCSIS SYNC messages using the local timestamp. Then, in step 610, QAM modulation and up-conversion is performed on the packets and the information is sent downstream to the CM and/or STB devices.

The concept of performing the QAM modulation remotely is not new. Modular CMTS defines a standard for sending transmitting data as packets over an Ethernet connection to an edge QAM device. In order to forward DOCSIS data, the edge QAM must be synchronized to the DOCSIS clock. This is done using a DOCSIS standard known as the DOCSIS Timing Interface (DTI). The systems and methods disclosed herein differ from modular CMTS in a couple of distinct ways. For example, the remote QAM modulation disclosed herein does not require usage of DTI. This is an important distinction because it is not feasible to extend DTI out to the fiber node. DTI is not required because the QAM modulation is co-located with the upstream demodulation in the fiber node. A locally-generated clock which tracks the DOCSIS timestamp is therefore sufficient to maintain the tight synchronization required between the downstream and upstream interfaces.

Another significant difference from modular CMTS is that the QAM modulation is performed in the fiber node, not in an edge device. Performing the QAM modulation in the fiber node allows a packet-based interface to be used all of the way out to the fiber node, thereby obviating the need for expensive amplitude modulated lasers in the network and avoiding the issues associated with amplitude modulated lasers (such as clipping). Also, the packet-based network allows downstream data for all subnodes to be sent on a common interface. It should be noted that a common interface does not necessarily imply a single fiber wavelength. In the current art, 10 Gb/s is the practical limit for a single fiber/wavelength when sending digital data over a fiber. This must be compared to the total downstream bandwidth which can be sent as a modulated analog signal over a single fiber/wavelength, which is about 6 Gb/s. Therefore, if the fiber node is split into 4 sub-nodes, multiple fibers and/or wavelengths are required either way to carry the 24 Gb/s of bandwidth. However, usage of a digital network interface such as Ethernet allows for less expensive implementation of the required technologies such as Dense Wavelength Division Multiplexing (DWDM). It is noted that the same protocol used by modular CMTS systems in the downstream direction, namely the Downstream External PHY Interface (DEPI), may also be employed when performing QAM modulation in the fiber node.

As described herein, the systems and methods disclosed require both the upstream demodulation and downstream modulation to be located in the fiber node in order to make the remote QAM modulation work. This is due to the lack of a precise reference clock between the CMTS and the fiber node. Without a precise reference clock, the demodulation cannot be performed in the CMTS while the modulation is performed in the fiber node. An alternative is presented herein which allows either downstream QAM modulation or upstream demodulation to be implemented in the fiber node independently. In the CMTS, the Ethernet clock may be locked to the CMTS timestamp clock. This clock may then be recovered by the fiber node and converted into local timestamp and symbol clocks such that the fiber node's QAM modulation function remains tightly synchronized to the CMTS. A standard already exists, known as Synchronous Ethernet, which enables this type of precise synchronization between devices attached via Ethernet.

Having thus described the invention in detail, it is to be understood that the foregoing description is not intended to limit the spirit or scope thereof. What is desired to be protected is set forth in the following claims.

1. A method of adding Quadrature Amplitude Modulation (QAM) demodulation at a fiber node of a Data Over Cable Service Interface Specification (DOCSIS) system to allow packet based digital transmission in an upstream fiber portion of a DOCSIS Hybrid Fiber Coax (HFC) plant over a single fiber or wavelength, said fiber node in communication with a plurality of cable modems (CMs) on a coaxial portion of the plant, and a cable modem termination system (CMTS) on a fiber portion of the plant, the method comprising:
synchronizing the fiber node to a DOCSIS timestamp clock;
obtaining channel configuration characteristics at the fiber node by parsing a DOCSIS Upstream Channel Descriptor (UCD) messages; and
determining, at the fiber node, beginning and ending times of upstream burst transmissions by using scheduling information contained within a DOCSIS MAP;
the fiber node separately demodulating data from a plurality of sub-nodes attached to the fiber node;
the fiber node combining the demodulated data from a plurality of sub-nodes onto a common upstream packet based network for transmission to the CMTS, and
the fiber node performing QAM modulation of downstream data transmitted to the fiber node from the CMTS.

2. (canceled)

3. The method of claim 2 further comprising obtaining precise DOCSIS timing reference to align burst transmissions in an upstream direction and demodulate said transmissions.

4. The method of claim 1, further comprising obtaining, at the fiber node, a precise timing reference over an Ethernet interface using Synchronous Ethernet, wherein the CMTS synchronizes an Ethernet clock using a DOCSIS clock and the fiber node derives a local DOCSIS clock from the Ethernet clock.

5. The method of claim 1, wherein the fiber node sets a local copy of a DOCSIS timestamp using DOCSIS SYNC messages, and generates a local timestamp clock from which a downstream symbol clock is derived, with the frequency of said local clock being modified to track timestamps received in the DOCSIS SYNC messages.

6. The method of claim 1, further comprising using an Ethernet Passive Optical Network for layer 2 transmission of demodulated data to the CMTS.

7. The method of claim 1, further comprising using an Ethernet interface for layer 2 transmission of demodulated data to the CMTS.

8. The method of claim 7, further comprising using a DOCSIS Upstream External PHY Interface (UEPI) for carrying upstream DOCSIS data over the Ethernet interface.

9. A method of adding quadrature amplitude modulation (QAM) modulation to a fiber node of a Data Over Cable Service Interface Specification (DOCSIS) system to allow packet based digital transmission methods in a downstream fiber portion of a DOCSIS Hybrid Fiber Coax (HFC) plant, with said fiber node in communication with a plurality of cable modems (CMs) on a coaxial portion of the plant, and a cable modem termination system (CMTS) on a fiber portion of the plant, the method comprising:
receiving digital packets at the fiber node from the CMTS in the downstream direction;
modulating the digital packets at the fiber node onto the coaxial portion of the plant using standardized DOCSIS QAM modulation techniques;
the fiber node locking onto the stream of DOCSIS SYNC messages sent from the CMTS; and
the fiber node re-stamping the DOCSIS SYNC messages by sending a local copy of a DOCSIS timestamp in DOCSIS SYNC messages forwarded to the CMs.

10. The method of claim 9, further comprising generating a local DOCSIS timestamp clock from the fiber node, with the frequency of said clock adjusted to keep to a local DOCSIS timestamp counter value synchronized with values received from the CMTS in DOCSIS SYNC messages, wherein MAPs, which are generated by the CMTS, remain synchronized with upstream communications.

11. The method of claim 9, further comprising recovering a local DOCSIS timestamp clock at the fiber node from DOCSIS SYNC messages sent by the CMTS using a fiber link, and demodulating data at the CMTS.

12. The method of claim 9, further comprising using an Ethernet connection for layer 2 transmission of digital data to the fiber node over the downstream fiber link.

13. The method of claim 9, further comprising using a DOCSIS Downstream External PHY Interface (DEPI), for carrying DOCSIS downstream data over the Ethernet to the fiber node.

14. A method of performing a fiber node split in a Data over Cable Service Interface Specification (DOCSIS) cable system comprising:
splitting coaxial legs of the fiber node into sub-nodes;
separately demodulating each sub-node in the fiber node into resultant digital data;
multiplexing the resultant digital data as packets onto a single Ethernet fiber link to a cable modem termination system (CMTS);
receiving non-modulated data at the fiber node from the CMTS over an Ethernet fiber; and
modulating the data at the fiber node using Quadrature Amplitude Modulation (QAM) onto separate downstream interfaces over coaxial cables to CMs and/or STBs.

15. (canceled)

16. A system for fiber node splits in a Date over Cable Service Interface Specification (DOCSIS) cable system comprising:
a cable modem termination system (CMTS);
a fiber node remote from the CMTS and in communication with the CMTS over Ethernet fiber, the fiber node having a modulator, demodulator and a diplexer; and
a plurality of cable modems (CMs) or set-top boxes (STBs) in communication with the fiber node over coaxial legs;
wherein, the demodulator sends multiplexed information from the CMs or STBs to the CMTS over the Ethernet fiber, and wherein the CMTS sends unmodulated data packets to the fiber node over the Ethernet fiber, and the fiber node modulates said data using Quadrature Amplitude Modulation (QAM) for transmission to the plurality of CMs or STBs.
